(19) United States
(12) Patent Application Publication
(10) Pub. No.: US 2014/0190449 A1
(43) Pub. Date: Jul. 10, 2014

(54) SYSTEM AND METHOD FOR RANDOMLY ADJUSTING A FIRING FREQUENCY OF AN ENGINE TO REDUCE VIBRATION WHEN CYLINDERS OF THE ENGINE ARE DEACTIVATED

(71) Applicant: GM GLOBAL TECHNOLOGY OPERATIONS LLC, Detroit, MI (US)

(72) Inventor: ANDREW W. PHILLIPS, Rochester, MI (US)

(73) Assignee: GM Global Technology Operations LLC, Detroit, MI (US)

(21) Appl. No.: 13/798,775

(22) Filed: Mar. 13, 2013

Related U.S. Application Data
(60) Provisional application No. 61/749,510, filed on Jan. 7, 2013.

(51) Int. Cl. F02P 5/00

(52) U.S. Cl. CPC F02P 5/00
USPC 123/406.12

(57) ABSTRACT

A system according to the principles of the present invention includes a firing fraction module, an offset generation module, and a firing fraction module. The firing fraction module determines a firing fraction based on a driver torque request. The offset generation module randomly generates an offset. The firing control module adds the firing fraction to a running total each time that a crankshaft of an engine rotates through a predetermined angle, adds the offset to the running total, and executes a firing event in a cylinder of the engine when the running total is greater than or equal to a predetermined value.

### CROSS-REFERENCE TO RELATED APPLICATIONS

This application claims the benefit of U.S. Provisional Application No. 61/749,526, filed on Jan. 7, 2013. The disclosure of the above application is incorporated herein by reference in its entirety.

This application is related to U.S. patent application Ser. No. ______ (HDP Ref. No. 8540P-001335) filed on [the same day], ______ (HDP Ref. No. 8540P-001336) filed on [the same day], ______ (HDP Ref. No. 8540P-001337) filed on [the same day], ______ (HDP Ref. No. 8540P-001342) filed on [the same day], ______(HDP Ref. No. 8540P-001343) filed on [the same day], ______ (HDP Ref. No. 8540P-001344) filed on [the same day], ______ (HDP Ref. No. 8540P-001345) filed on [the same day], ______ (HDP Ref. No. 8540P-001346) filed on [the same day], ______ (HDP Ref. No. 8540P-001347) filed on [the same day], ______ (HDP Ref. No. 8540P-001348) filed on [the same day], ______ (HDP Ref. No. 8540P-001349) filed on [the same day], ______ (HDP Ref. No. 8540P-001350) filed on [the same day], ______ (HDP Ref. No. 8540P-001351) filed on [the same day], ______ (HDP Ref. No. 8540P-001352) filed on [the same day], ______ (HDP Ref. No. 8540P-001359) filed on [the same day], ______ (HDP Ref. No. 8540P-001362) filed on [the same day], ______ (HDP Ref. No. 8540P-001363) filed on [the same day, and ______ (HDP Ref. No. 8540P-001368) filed on [the same day]. The entire disclosures of the above applications are incorporated herein by reference.

### FIELD

The present disclosure relates to systems and methods for randomly adjusting a firing frequency of an engine to reduce vibration when cylinders of the engine are deactivated.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Internal combustion engines combust an air and fuel mixture within cylinders to drive pistons, which produces drive torque. Air flow into the engine is regulated via a throttle. More specifically, the throttle adjusts throttle area, which increases or decreases air flow into the engine. As the throttle area increases, the air flow into the engine increases. A fuel control system adjusts the rate that fuel is injected to provide a desired air/fuel mixture to the cylinders and/or to achieve a desired torque output. Increasing the amount of air and fuel provided to the cylinders increases the torque output of the engine.

In spark-ignition engines, spark initiates combustion of an air/fuel mixture provided to the cylinders. In compression-ignition engines, compression in the cylinders combusts the air/fuel mixture provided to the cylinders. Spark timing and air flow may be the primary mechanisms for adjusting the torque output of spark-ignition engines, while fuel flow may be the primary mechanism for adjusting the torque output of compression-ignition engines.

Under some circumstances, one or more cylinders of an engine may be deactivated to decrease fuel consumption. For example, one or more cylinders may be deactivated when the engine can produce a requested amount of torque while the cylinder(s) are deactivated. Deactivation of a cylinder may include disabling opening of intake and exhaust valves of the cylinder and disabling spark and fueling of the cylinder.

### SUMMARY

A system according to the principles of the present invention includes a firing fraction module, an offset generation module, and a firing fraction module. The firing fraction module determines a firing fraction based on a driver torque request. The offset generation module randomly generates an offset. The firing control module adds the firing fraction to a running total each time that a crankshaft of an engine rotates through a predetermined angle, adds the offset to the running total, and executes a firing event in a cylinder of the engine when the running total is greater than or equal to a predetermined value.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example engine system according to the principles of the present disclosure;

FIG. 2 is a functional block diagram of an example control system according to the principles of the present disclosure; and

FIG. 3 is a flowchart illustrating an example control method according to the principles of the present disclosure.

In the drawings, reference numbers may be reused to identify similar and/or identical elements.

### DETAILED DESCRIPTION

A firing frequency of an engine may be adjusted to deactivate cylinders of an engine while satisfying a driver torque request. In one example, the firing frequency is adjusted using a firing fraction. A firing fraction is a ratio of a driver torque request to a maximum torque output of an engine when each cylinder in the engine is active. The firing fraction is added to a running total after each cylinder event in a firing order of the engine. A cylinder event refers to a crank angle increment in which spark is generated in a cylinder when the cylinder is active. When the running total is greater than or equal to a predetermined value (e.g., one), a firing event is executed in the next cylinder of the firing order and the predetermined value is subtracted from the running total.

In one example, an eight-cylinder engine may have a firing fraction of 0.5. Thus, if the running total is initially zero, the running total is equal to 0.5 after one cylinder event and a firing event is not executed. After two cylinder events, the running total is equal to one and a firing event is executed. The running total is then decreased by one, and incrementing the running total by the firing fraction continues in this manner such that a firing event is executed in every other cylinder of the engine.

Adjusting a firing frequency in the manner described above may yield a firing frequency that excites a natural resonance of a vehicle structure between powertrain mounts and driver interface components such as a seat, a steering wheel, and pedals. Noise and vibration at the driver interface components may be represented in the form of a spectral density generating using, for example, a fast Fourier transform. Exciting the natural resonances of the vehicle structure causes spikes in the spectral density, which may cause a driver to perceive an increase in the noise and vibration of a vehicle.

A control system and method according to the present disclosure randomly adjusts a firing frequency of an engine to reduce noise and vibration during cylinder deactivation. The firing fraction is added to the running total after each cylinder event in a firing order of the engine, and a firing event is executed in the next cylinder of the firing order when the running total is greater than or equal to a predetermined value. The firing frequency is randomly adjusted by randomly generating an offset and adding the offset to the running total before comparing the running total to the predetermined value. The offset may be selected from a range of values having a mean value of zero. Thus, adding the offset to the running total may pull ahead or delay the firing event.

Randomly adjusting the firing frequency of an engine yields noise and vibration having a relatively flat frequency distribution (e.g., white noise), which reduces the amount of noise and vibration that is perceived by a driver. In addition, randomly adjusting the firing frequency in the manner described above provides the ability to quickly respond to a change in a driver torque request. For example, when a driver completely depresses an accelerator pedal, the firing fraction may be increased to one such that a firing event is executed in the next cylinder of a firing order of the engine.

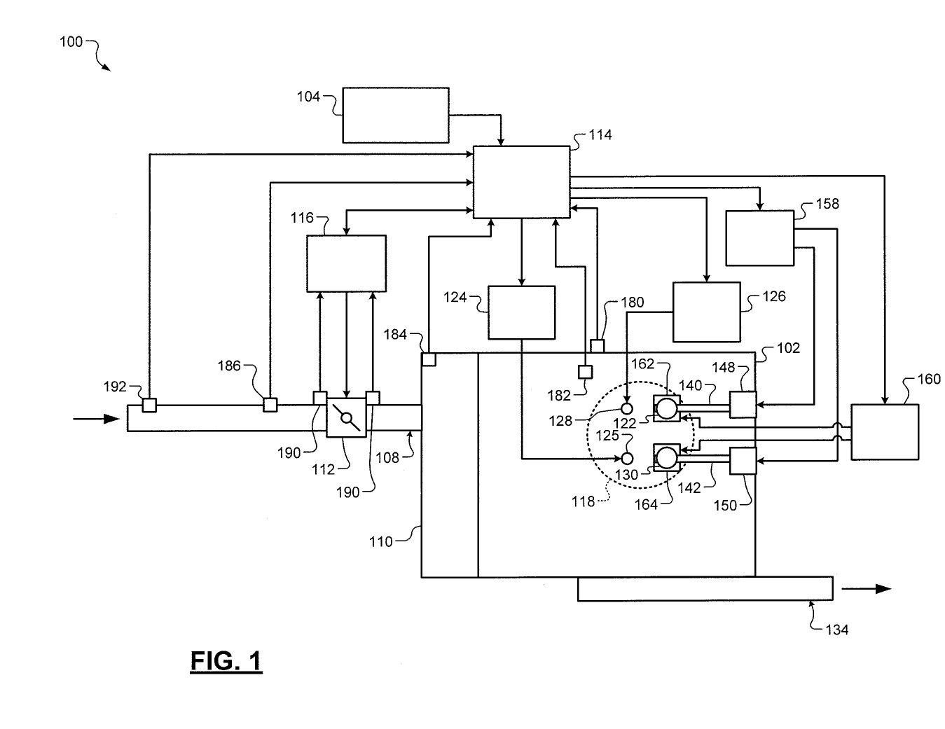

Referring now to FIG. 1, an engine system 100 includes an engine 102 that combusts an air/fuel mixture to produce drive torque for a vehicle. The amount of drive torque produced by the engine 102 is based on driver input from a driver input module 104. Air is drawn into the engine 102 through an intake system 108. The intake system 108 includes an intake manifold 110 and a throttle valve 112. The throttle valve 112 may include a butterfly valve having a rotatable blade. An engine control module (ECM) 114 controls a throttle actuator module 116, which regulates opening of the throttle valve 112 to control the amount of air drawn into the intake manifold 110.

Air from the intake manifold 110 is drawn into cylinders of the engine 102. For illustration purposes, a single representative cylinder 118 is shown. However, the engine 102 may include multiple cylinders. For example, the engine 102 may include 2, 3, 4, 5, 6, 8, 10, and/or 12 cylinders. The ECM 114 may deactivate one or more of the cylinders, which may improve fuel economy under certain engine operating conditions.

The engine 102 may operate using a four-stroke cycle. The four strokes include an intake stroke, a compression stroke, a combustion stroke, and an exhaust stroke. During each revolution of a crankshaft (not shown), two of the four strokes occur within the cylinder 118. Therefore, two crankshaft revolutions are necessary for the cylinder 118 to experience all four of the strokes.

During the intake stroke, air from the intake manifold 110 is drawn into the cylinder 118 through an intake valve 122. The ECM 114 controls a fuel actuator module 124, which regulates a fuel injector 125 to control the amount of fuel provided to the cylinder to achieve a desired air/fuel ratio. The fuel injector 125 may inject fuel directly into the cylinder 118 or into a mixing chamber associated with the cylinder 118. The fuel actuator module 124 may halt fuel injection into cylinders that are deactivated.

The injected fuel mixes with air and creates an air/fuel mixture in the cylinder 118. During the compression stroke, a piston (not shown) within the cylinder 118 compresses the air/fuel mixture. The engine 102 may be a compression-ignition engine, in which case compression in the cylinder 118 ignites the air/fuel mixture. Alternatively, the engine 102 may be a spark-ignition engine, in which case a spark actuator module 126 energizes a spark plug 128 in the cylinder 118 based on a signal from the ECM 114. The spark ignites the air/fuel mixture. The timing of the spark may be specified relative to the time when the piston is at its topmost position, referred to as top dead center (TDC).

The spark actuator module 126 may be controlled by a timing signal specifying how far before or after TDC to generate the spark. Because piston position is directly related to crankshaft rotation, operation of the spark actuator module 126 may be synchronized with crankshaft angle. In various implementations, the spark actuator module 126 may halt provision of spark to deactivated cylinders.

Generating the spark may be referred to as a firing event. A firing event causes combustion in a cylinder when an air/fuel mixture is provided to the cylinder (e.g., when the cylinder is active). The spark actuator module 126 may have the ability to vary the timing of the spark for each firing event. The spark actuator module 126 may even be capable of varying the spark timing for a next firing event when the spark timing signal is changed between a last firing event and the next firing event. In various implementations, the engine 102 may include multiple cylinders and the spark actuator module 126 may vary the spark timing relative to TDC by the same amount for all cylinders in the engine 102.

During the combustion stroke, the combustion of the air/fuel mixture drives the piston down, thereby driving the crankshaft. As the combustion of the air/fuel mixture drives the piston down, the piston moves from TDC to its bottommost position, referred to as bottom dead center (BDC).

During the exhaust stroke, the piston begins moving up from BDC and expels the byproducts of combustion through an exhaust valve 130. The byproducts of combustion are exhausted from the vehicle via an exhaust system 134.

The intake valve 122 may be controlled by an intake camshaft 140, while the exhaust valve 130 may be controlled by an exhaust camshaft 142. In various implementations, multiple intake camshafts (including the intake camshaft 140) may control multiple intake valves (including the intake valve 122) for the cylinder 118 and/or may control the intake valves (including the intake valve 122) of multiple banks of cylinders (including the cylinder 118). Similarly, multiple exhaust camshafts (including the exhaust camshaft 142) may control multiple exhaust valves for the cylinder 118 and/or may control exhaust valves (including the exhaust valve 130) for multiple banks of cylinders (including the cylinder 118).

The time at which the intake valve 122 is opened may be varied with respect to piston TDC by an intake cam phaser 148. The time at which the exhaust valve 130 is opened may be varied with respect to piston TDC by an exhaust cam phaser 150. The ECM 114 may disable opening of the intake and exhaust valves 122, 130 of cylinders that are deactivated. A phaser actuator module 158 may control the intake cam phaser 148 and the exhaust cam phaser 150 based on signals from the ECM 114. When implemented, variable valve lift (not shown) may also be controlled by the phaser actuator module 158.

The ECM 114 may deactivate the cylinder 118 by instructing a valve actuator module 160 to deactivate opening of the intake valve 122 and/or the exhaust valve 130. The valve actuator module 160 controls an intake valve actuator 162 that opens and closes the intake valve 122. The valve actuator module 160 controls an exhaust valve actuator 164 that opens and closes the exhaust valve 130. In one example, the valve actuators 162, 164 include solenoids that deactivate opening of the valves 122, 130 by decoupling cam followers from the camshafts 140, 142. In another example, the valve actuators 162, 164 are electromagnetic or electrohydraulic actuators that control the lift, timing, and duration of the valves 122, 130 independent from the camshafts 140, 142. In this example, the camshafts 140, 142, the intake and exhaust cam phasers 148, 150, and the phaser actuator module 158 may be omitted.

The position of the crankshaft may be measured using a crankshaft position (CKP) sensor 180. The temperature of the engine coolant may be measured using an engine coolant temperature (ECT) sensor 182. The ECT sensor 182 may be located within the engine 102 or at other locations where the coolant is circulated, such as a radiator (not shown).

The pressure within the intake manifold 110 may be measured using a manifold absolute pressure (MAP) sensor 184. In various implementations, engine vacuum, which is the difference between ambient air pressure and the pressure within the intake manifold 110, may be measured. The mass flow rate of air flowing into the intake manifold 110 may be measured using a mass air flow (MAF) sensor 186. In various implementations, the MAF sensor 186 may be located in a housing that also includes the throttle valve 112.

The throttle actuator module 116 may monitor the position of the throttle valve 112 using one or more throttle position sensors (TPS) 190. The ambient temperature of air being drawn into the engine 102 may be measured using an intake air temperature (IAT) sensor 192. The ECM 114 may use signals from the sensors to make control decisions for the engine system 100.

The ECM 114 adjusts a firing frequency of the engine 102 to deactivate cylinders while satisfying a driver torque request. The ECM 114 adds a firing fraction to a running total after each cylinder event in a firing order of the engine 102. A firing fraction is a ratio of a driver torque request to a maximum torque output of the engine 102 when all of the cylinders in the engine 102 are firing. A cylinder event refers to a crank angle increment in which spark is generated in a cylinder when the cylinder is active. The ECM 114 executes a firing event in the next cylinder of the firing order when the running total is greater than or equal to a predetermined value (e.g., one). The ECM 114 then subtracts the predetermined value from the running total.

The ECM 114 randomly adjusts the firing frequency of the engine 102 to reduce noise and vibration during cylinder deactivation. The ECM 114 accomplishes this by randomly generating an offset and adding the offset to the running total before determining whether the running total is greater than or equal to the predetermined value. The offset may be selected from a range of values having a mean value of zero. Thus, adding the offset to the running total may pull ahead or delay the firing event.

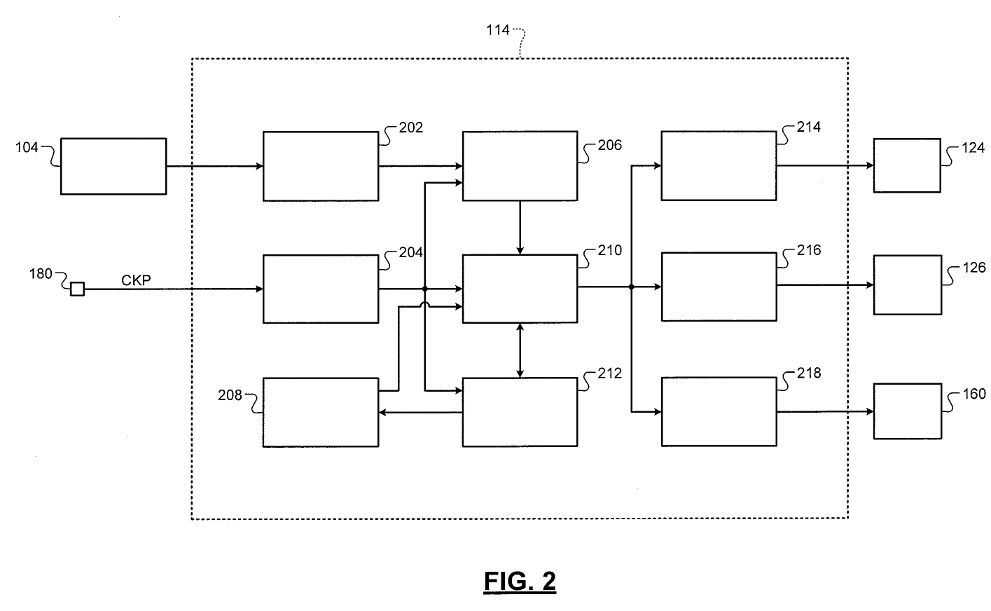

Referring to FIG. 2, an example implementation of the ECM 114 includes a torque request module 202, a cylinder event module 204, a firing fraction module 206, an offset generation module 208, and a firing control module 210. The torque request module 202 determines a driver torque request based on the driver input from the driver input module 104. The driver input may be based on a position of an accelerator pedal. The driver input may also be based on input from a cruise control system, which may be an adaptive cruise control system that varies vehicle speed to maintain a predetermined following distance. The torque request module 202 may store one or more mappings of accelerator pedal position to desired torque, and may determine the driver torque request based on a selected one of the mappings. The torque request module 202 outputs the driver torque request.

The cylinder event module 204 determines when a cylinder event is complete based on input received from the CKP sensor 180. The cylinder event module 204 may determine that a cylinder event is complete when the crankshaft rotates by a predetermined amount. For example, for an eight-cylinder engine that executes four firing events every 360 degrees of crankshaft rotation when all cylinders are active, each cylinder event may correspond to 90 degrees of crankshaft rotation. The cylinder event module 204 outputs a signal indicating when a cylinder event is complete.

The firing fraction module 206 determines a firing fraction based on the driver torque request and the maximum torque output of the engine 102 when all of the cylinders in the engine 102 are firing. The firing fraction module 206 divides the driver torque request by the maximum torque output of the engine 102 to obtain the firing fraction. The firing fraction module 206 may adjust the firing fraction after each cylinder event. The firing fraction module 206 outputs the firing fraction.

The offset generation module 208 randomly generates an offset. The offset generation module 208 may select the offset from a range of values having a mean value of zero. In one example, offset generation module 208 may select the offset from a range of values between a negative value of the firing fraction and a positive value of the firing fraction. The offset generation module 208 outputs the offset.

The firing control module 210 adds the firing fraction to a running total after each cylinder event and executes a firing event in the next cylinder of the firing order when the running total is greater than or equal to one. The firing control module 210 may add the offset to the running total before determining whether the running total is greater than or equal to one. Since the offset may be a positive or a negative, adding the offset to the running total may pull ahead or delay the firing event. The firing control module 210 subtracts one from the running total after executing a firing event.

A firing frequency module 212 determines a firing frequency of the engine 102. The firing frequency module 212 may determine the firing frequency based on input received from the CKP sensor 180 and the firing control module 210. For example, the firing frequency module 212 may divide the number of firing events by a corresponding amount of crankshaft rotation to obtain the firing frequency. The firing frequency module 212 outputs the firing frequency.

The offset generation module 208 may adjust the range from which the offset is selected based on the firing frequency. For example, the offset generation module 208 may increase the range as the firing frequency approaches resonant frequency of a vehicle structure between powertrain mounts and driver interface components such as a seat, a steering wheel, and pedals. The excitation frequencies may be predetermined using, for example, modal analysis and/or physical testing.

In one example, the offset generation module 208 may increase the range from zero to a range having a negative lower limit, a positive upper limit, and a mean value of zero. The negative lower limit may be equal to a negative value of the firing fraction, or a fraction thereof, and the positive upper limit may be equal to a positive value of the firing fraction, or a fraction thereof. In various implementations, the offset generation module 208 may set the offset equal to a sinusoidal signal that varies between the upper and lower limits with respect to time or crankshaft rotation.

In addition to or instead of adjusting the range from which the offset is selected based on the firing frequency, the firing control module 210 may determine whether to add the offset to the running total based on the firing frequency. For example, the firing control module 210 may add the offset to the running total when the firing frequency is within a predetermined range of a resonant frequency of the vehicle structure. Conversely, the firing control module 210 may not add the offset to the running total when the firing frequency is outside of the predetermined range.

The fuel control module 214 instructs the fuel actuator module 124 to provide fuel to a cylinder of the engine 102 to execute a firing event in the cylinder. The spark control module 216 instructs the spark actuator module 126 to generate spark in a cylinder of the engine 102 to execute a firing event in the cylinder. The valve control module 218 instructs the valve actuator module 160 to open intake and exhaust valves of a cylinder to execute a firing event in the cylinder.

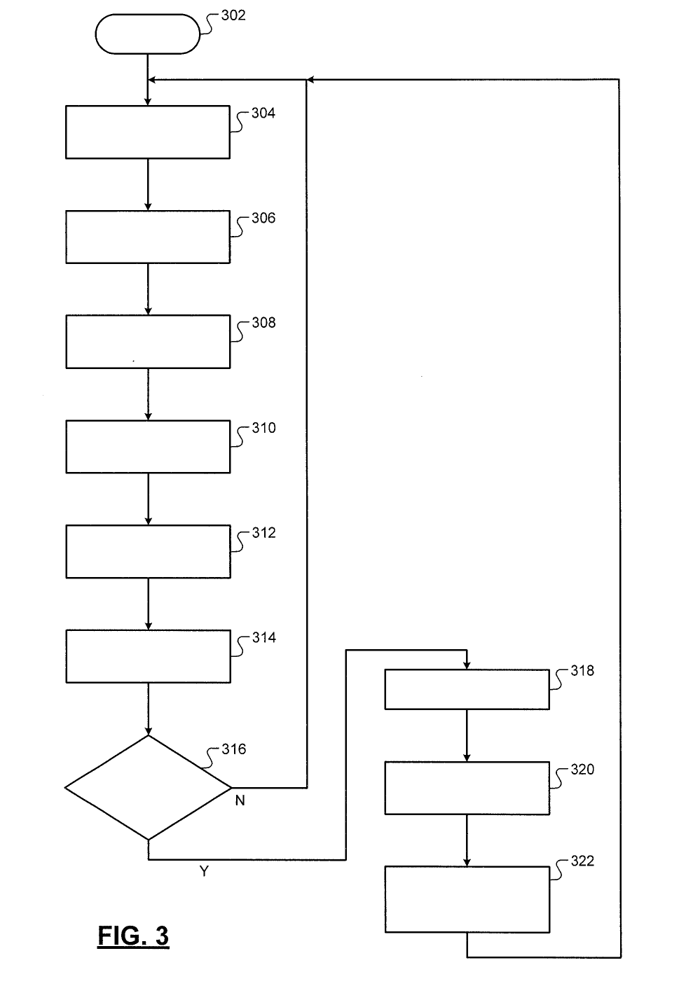

Referring now to FIG. 3, a method for randomly adjusting a firing frequency of an engine to reduce vibration when cylinders of the engine are deactivated begins at 302. At 304, the method determines a firing fraction based on a driver torque request and a maximum torque output of the engine when all of the cylinders of the engine are firing. The method divides the driver torque request by the maximum torque output to obtain the firing fraction. The method may determine the driver torque request based on an accelerator pedal position and/or a cruise control setting.

At 306, the method adds the firing fraction to a running total. The running total may be set to zero when the engine is initially started. At 308, the method determines a firing frequency of the engine. The method may determine the firing frequency based on the amount of crankshaft rotation and/or the amount of time between firing events.

At 310, the method determines an offset range. The method may adjust the offset range based on the firing frequency. For example, the method may increase the offset range as the firing frequency approaches a resonant frequency of a vehicle structure between powertrain mounts and driver interface components such as a seat, a steering wheel, and pedals. The excitation frequencies may be predetermined using, for example, modal analysis and/or physical testing. In one example, the method may increase the offset range from zero to a range having a negative lower limit, a positive upper limit, and a mean value of zero. The negative lower limit may be equal to a negative value of the firing fraction, or a fraction thereof, and the positive upper limit may be equal to a positive value of the firing fraction, or a fraction thereof. In various implementations, the method may set the offset equal to a sinusoidal signal that varies between the upper and lower limits with respect to time or crankshaft rotation.

At 312, the method randomly generates an offset. For example, the method may randomly select an offset from the offset range. At 314, the method adds the offset to the running total. In various implementations, the method may add the offset to the running total when the firing frequency is within a predetermining range of a resonant frequency of the vehicle structure. Conversely, the method may not add the offset to the running total when the firing frequency is outside of the predetermining range.

At 316, the method determines whether the running total is greater than or equal to one. If the running total is greater than or equal to one, the method continues at 318. Otherwise, the method continues at 304. At 318, the method executes a firing event in the next cylinder of a firing order of the engine.

At 320, the method subtracts the offset from the running total. In this regard, the method may only temporarily add the offset to the running total at 314, and then subtract the offset from the running total after the determination is made at 316. Subtracting the offset from the running total may minimize or eliminate the effect of the method on the average firing fraction or firing frequency over a sufficiently long sequence of cylinder events (e.g., over one or more complete rotations of a crankshaft). In turn, the driver may not perceive a change in torque output due to a change in the average firing fraction or firing frequency.

In various implementations, the method may not subtract the offset from the running total (e.g., 320 may be omitted). In these implementations, the mean of the offsets added to the running total may be zero. Thus, the method may have no effect on the average firing fraction or firing frequency over a sufficiently long sequence of cylinder events.

At 322, the method subtracts one from the running total and continues at 304. The method may complete one iteration of the control loop of FIG. 3 for each cylinder event (e.g., each time that a crankshaft rotates through a predetermined angle). Thus, the method may evaluate and/or adjust the firing fraction on a cylinder-by-cylinder basis.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

In this application, including the definitions below, the term module may be replaced with the term circuit. The term module may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term code, as used above, may include software, firmware, and/or microcode, and may refer to programs, routines, functions, classes, and/or objects. The term shared processor encompasses a single processor that executes some or all code from multiple modules. The term group processor encompasses a processor that, in combination with additional processors, executes some or all code from one or more modules. The term shared memory encompasses a single memory that stores some or all code from multiple modules. The term group memory encompasses a memory that, in combination with additional memories, stores some or all code from one or more modules. The term memory may be a subset of the term computer-readable medium. The term computer-readable medium does not encompass transitory electrical and electromagnetic signals propagating through a medium, and may therefore be considered tangible and non-transitory. Non-limiting examples of a non-transitory tangible computer readable medium include nonvolatile memory, volatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

What is claimed is:

1. A system comprising:
a firing fraction module that determines a firing fraction based on a driver torque request;
an offset generation module that randomly generates an offset; and
a firing control module that:
adds the firing fraction to a running total each time that a crankshaft of an engine rotates through a predetermined angle;
adds the offset to the running total; and
executes a firing event in a cylinder of the engine when the running total is greater than or equal to a predetermined value.

2. The system of claim 1 wherein the firing fraction module sets the firing fraction equal to a ratio of the driver torque request to a torque output of the engine when each cylinder in the engine is active.

3. The system of claim 1 wherein the firing control module subtracts the offset from the running total after determining whether the running total is greater than or equal to the predetermined value.

4. The system of claim 1 wherein the firing control module subtracts the predetermined value from the running total after executing the firing event.

5. The system of claim 1 further comprising a firing frequency module that determines a firing frequency of the engine based on an amount of crankshaft rotation between firing events.

6. The system of claim 1 wherein the firing control module adds the offset to the running total each time that the crankshaft rotates through the predetermined angle.

7. The system of claim 6 wherein the firing control module adds the offset to the running total when a firing frequency of the engine is within a predetermined range of a resonant frequency of a vehicle structure.

8. The system of claim 1 wherein the offset generation module randomly selects the offset from an offset range having a mean value of zero.

9. The system of claim 8 wherein the offset generation module increases the offset range when a difference between a firing frequency of the engine and a resonant frequency of a vehicle structure decreases.

10. The system of claim 8 wherein the offset generation module increases the offset range from zero to a non-zero value when a firing frequency of the engine is within a predetermined range of a resonant frequency of a vehicle structure.

11. A method comprising:
determining a firing fraction based on a driver torque request;
randomly generates an offset;
adding the firing fraction to a running total each time that a crankshaft of an engine rotates through a predetermined angle;
adding the offset to the running total; and
executing a firing event in a cylinder of the engine when the running total is greater than or equal to a predetermined value.

12. The method of claim 11 further comprising setting the firing fraction equal to a ratio of the driver torque request to a torque output of the engine when each cylinder in the engine is active.

13. The method of claim 11 further comprising subtracting the offset from the running total after determining whether the running total is greater than or equal to the predetermined value.

14. The method of claim 11 further comprising subtracting the predetermined value from the running total after executing the firing event.

15. The method of claim 11 further comprising determining a firing frequency of the engine based on an amount of crankshaft rotation between firing events.

16. The method of claim 11 further comprising adding the offset to the running total each time that the crankshaft rotates through the predetermined angle.

17. The method of claim 16 further comprising adding the offset to the running total when a firing frequency of the engine is within a predetermined range of a resonant frequency of a vehicle structure.

18. The method of claim 11 further comprising randomly selecting the offset from an offset range having a mean value of zero.

19. The method of claim 18 further comprising increasing the offset range when a difference between a firing frequency of the engine and a resonant frequency of a vehicle structure decreases.

20. The method of claim 18 further comprising increasing the offset range from zero to a non-zero value when a firing frequency of the engine is within a predetermined range of a resonant frequency of a vehicle structure.
